(19) United States
(12) Patent Application Publication
(10) Pub. No.: US 2022/0245599 A1
(43) Pub. Date: Aug. 4, 2022

(54) SYSTEM AND METHOD FOR ECONOMICALLY DRIVEN PREDICTIVE DEVICE SERVICING

(71) Applicant: Toshiba TEC Kabushiki Kaisha, Shinagawa-ku (JP)

(72) Inventors: Marianne KODIMER, Huntington Beach, CA (US); Harrison B. BOOKER, Foothill Ranch, CA (US)

(21) Appl. No.: 17/167,310

(22) Filed: Feb. 4, 2021

(51) Int. Cl. G06Q 10/00; G06Q 30/02; G06F 17/11

(52) U.S. Cl. CPC G06Q 10/20; G06F 17/11; G06Q 30/0284

(57) ABSTRACT

A system and method for economically driven predictive device servicing commences with receipt of a job service ticket for a multifunction peripheral. A location of the device is determined and other devices with predicted parts failures or servicing needs that are reasonably proximate to the multifunction peripheral are identified. For each identified device, a determination is made as to whether servicing costs, such as parts, labor and travel, are less than a cost of a separate service call for that device. Cost may include a replacement part cost relative to anticipated remaining part life. Devices that are determined to be economically serviced contemporaneously with the multifunction peripheral are flagged, and device maintenance scheduled and performed by a technician.

### TECHNICAL FIELD

This application relates generally to cost effective servicing of document processing devices. The application relates more particularly to contemporaneous servicing of geographically proximate devices in accordance with predictive need based on parts cost, estimated remaining life, and cost of device servicing.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFP means any of the forgoing.

MFP devices are complex devices that are subject to failures. When devices fail, an end user will initiate a service call. Device failures can be particularly frustrating for device users. Failures can result in periods when a MFP is out of service, leaving users without a powerful office tool and can cause user frustration when a job must wait or an alternative MFP used, such as one that is not conveniently located or one without needed capabilities that were available on the out of service MFP.

Not only are failed devices a burden on end users, they can provide significant financial cost to MFP providers. A common business model for MFPs is one wherein a distributor enters into an end user agreement where the distributer provides a device at little or no upfront cost to the end user. User charges are based a cost per page. This cost reflects device usage charges, as well as maintenance costs. Significant human resource costs are associated with receiving a service call, logging a call, scheduling a service time, dispatching a service technician, and diagnosing and repairing the device. Such service costs can lower the distributor's profitability, increase the end user's cost per page, or both.

### BRIEF DESCRIPTION OF THE DRAWINGS

Various embodiments will become better understood with regard to the following description, appended claims and accompanying drawings wherein:

FIG. 1 is an example embodiment of a system 100 economically driven predictive device servicing;

FIG. 2 is a networked document rendering system;

FIG. 3 is an example embodiment of a digital data processing device;

FIG. 4 is a flow diagram of a device error prediction system;

FIG. 5 is a flow diagram of an example embodiment of a machine learning system;

FIG. 6 is an illustration of example machine learning algorithms;

FIG. 7 illustrates example visual depictions of machine learning algorithm results;

FIG. 8 is an example embodiment of a breakdown of device symptoms;

FIG. 9 is an example embodiment of resolution of device failures;

FIG. 10 is a flowchart of a system for economically driven predictive device servicing;

FIG. 11 is an example of an undirected, weighted graph; and

FIG. 12 is an example embodiment of weighted graphs facilitating determination if device servicing is cost effective.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with example embodiments herein, a recommendation engine functions to alert service managers when a customer service call is predicted and thereby promote preventative maintenance and increase customer satisfaction. Unfortunately, dealers can lose money by replacing a part before its end of life. This expense is greater the longer the life left of a prematurely replaced part, and therefore prediction accuracy is desirable. Sending a service technician on a service call based on predicted failures with, for example, less than 80% accuracy may not be viewed as cost effective from a dealer's perspective.

Example embodiments disclosed herein provide service value by adding a cost threshold for replacing parts for the device to the recommendation engine's failure predictions in question, in addition other devices in the area. As a result, the system suggests to a dealer when to make service calls when they are deemed cost effective. Call prediction is enhanced by factoring in a cost of replacing a part, an end-of-lifetime of a part, and a customer location to generate a value of service recommendation and service implementation.

In example embodiments, a process is first triggered when a new service call comes in. A list of device identifiers, such as serial numbers, is obtained for all devices within a prescribed distance boundary. By way of example, a boundary may be set at 10 miles (approximately 16 kilometers) of a device for which a device service ticket is entered. Devices associated with retrieved serial numbers are referenced by the predictive maintenance system to obtain daily predictions for these relatively proximate devices. Devices without any imminent predicted failures are filtered out, leaving only relatively proximate devices that are predicted to have some part failure. For each remaining adjacent device, distance and cost information is gathered and service is recommend or scheduled if it is economical to do so.

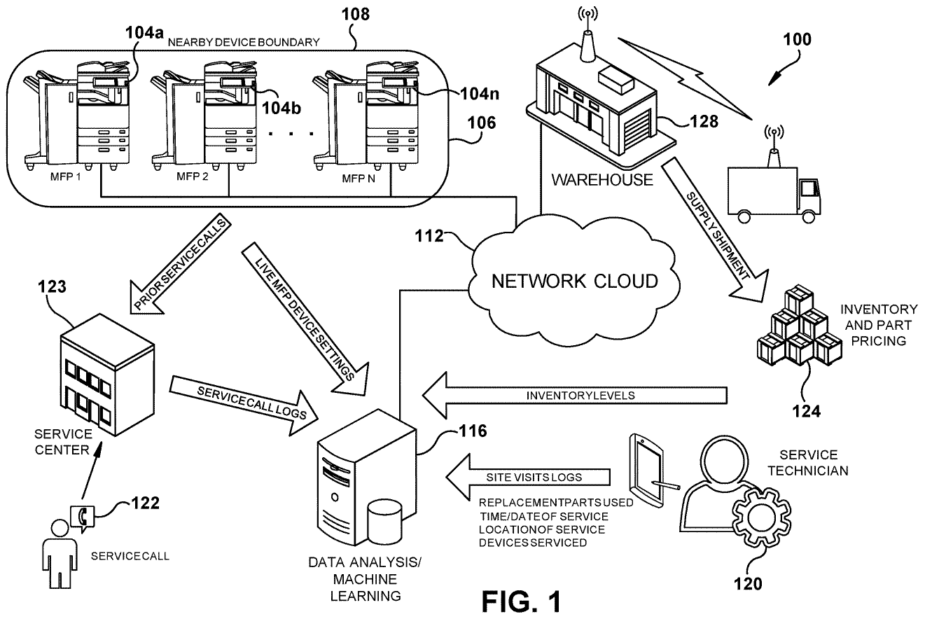

Turning to FIG. 1, illustrated is example embodiment of a system 100 that includes a plurality of MFPs 104, illustrated with 104a, 104b through 104n. The MFPs 104 are dispersed geographically. One or more MFPs 104 may be located at within a nearby service boundary 108, over multiple locations for a single business, or among multiple businesses. In the illustrated example, all MFPs have been deemed to be relatively proximate insofar as all fall within the nearby service boundary 108. All MFPs 104 are configured for data communication via a network cloud 112, suitably comprised of some or all of a local area network (LAN) or wide area network (WAN) which may comprise the global Internet. Also in data communication with network cloud 112 is a data analysis and machine learning service suitably including one or more servers as illustrated by server 116. MFPs 104 each include one or more components configured to monitor one or more states of the device which are reported to server 116 which also stores additional information such as repair histories and device maintenance schedules, suitably coordinated with one or more service technicians. Server 116 also stores location information for MFPs 104. Location information is suitably a geographic location determined for each MFP 104. Location information may be preset by a device physical location description, device installation address, device IP address information, and the like. Location information may also be determined by an MFP 104 itself, such as with GPS positioning, cell tower sector positioning, RF triangulation, or the like.

Server 116 accumulates MFP device status data including a current device state for each MFP 104, which data is suitably obtained by real time reporting, a periodic polling by the server, or periodic reporting initiated for each MFP 104 or MFP network. Device state data may include data reflective of error conditions, device settings, page counts, or toner or ink levels. Server 116 also receives service call log data from one or more service centers such as service center 123. Service call log data suitably includes timing and dates of device services, part replacements made, and the like. This data forms predictive parts failure data by application of any suitable machine learning. Server 116 also suitably stores inventory data corresponding to replacement parts and their associated cost.

Device servicing may be typically initiated by a customer service call 122. An incoming service call is logged and ultimately a service technician 120 is dispatched to address an associated device issue. Service technician 120 then fixes the associated device using one or more replacement parts and a report is then sent to server 116. Remaining devices within the nearby service boundary 108 are also serviced on the same service call dispatch when it is determined to be cost effective to do so, as will be detailed below. Replacement parts for contemporaneous device servicing is suitably obtained from local inventory 124, suitably stocked by delivery from warehouse 128.

A technician service report may include a list of a replacement part or parts used, a time or date of service, a/the location(s) of service, identification of service devices, and the like. Such information is suitably provide to server 116 to update and refine predictive failure modeling.

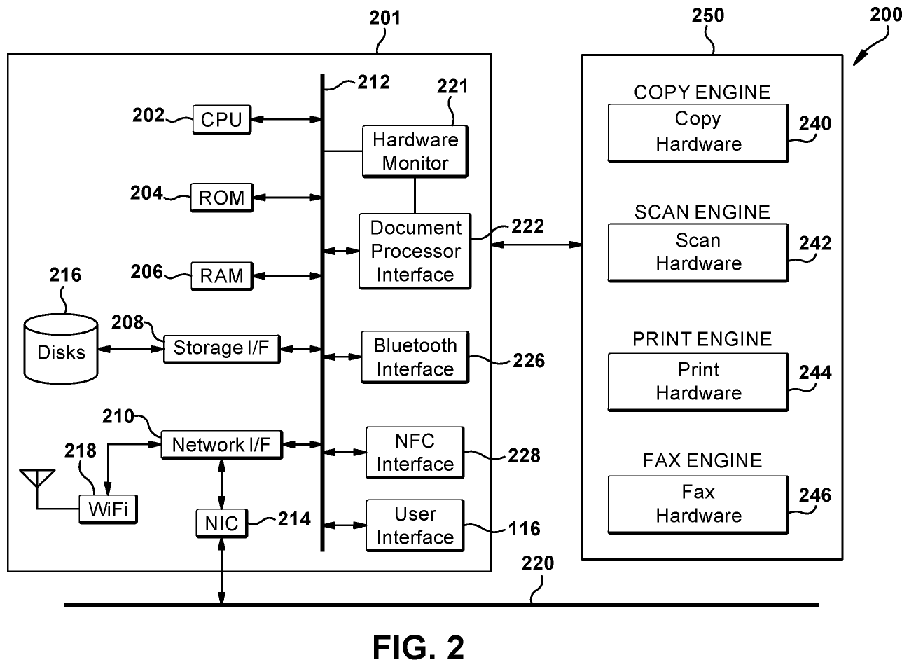

Turning now to FIG. 2, illustrated is an example embodiment of a networked digital device comprised of document rendering system 200 suitably comprised within an MFP, such as with MFPs 104 of FIG. 1. It will be appreciated that an MFP includes an intelligent controller 201 which is itself a computer system. Thus, an MFP can itself function as a cloud server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless data connections include cellular, Wi-Fi, Bluetooth, NFC, wireless universal serial bus (wireless USB), satellite, and the like. Example wired interfaces include Ethernet, USB, IEEE 1394 (FireWire), Lightning, telephone line, or the like. Processor 202 is also in data communication with user interface 219 or interfacing with displays, keyboards, touchscreens, mice, trackballs and the like.

Processor 202 can also be in data communication with any suitable user input/output (I/O) interface 219 which provides data communication with user peripherals, such as displays, keyboards, mice, track balls, touch screens, or the like.

Also in data communication with data bus 212 is a document processor interface 222 suitable for data communication with the document rendering system 200, including MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

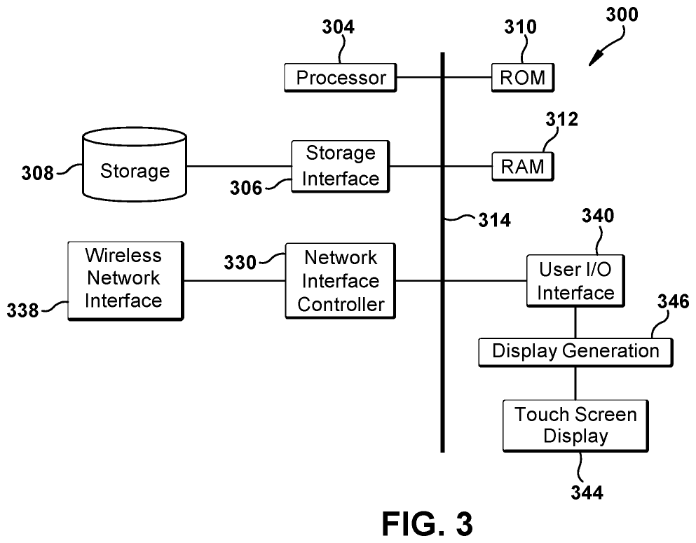

Turning now to FIG. 3, illustrated is an example embodiment of a digital data processing device 300 such as server 116 of FIG. 1. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. A network interface controller 330 suitably provides a gateway for data communication with other devices, such as via wireless network interface 338 A user input/output interface 340 suitably provides display generation 346 providing a user interface via touchsreen display 344, suitably comprised of a touch-screen display. It will be understood that the computational platform to realize the system as detailed further below is suitably implemented on any or all of devices as described above.

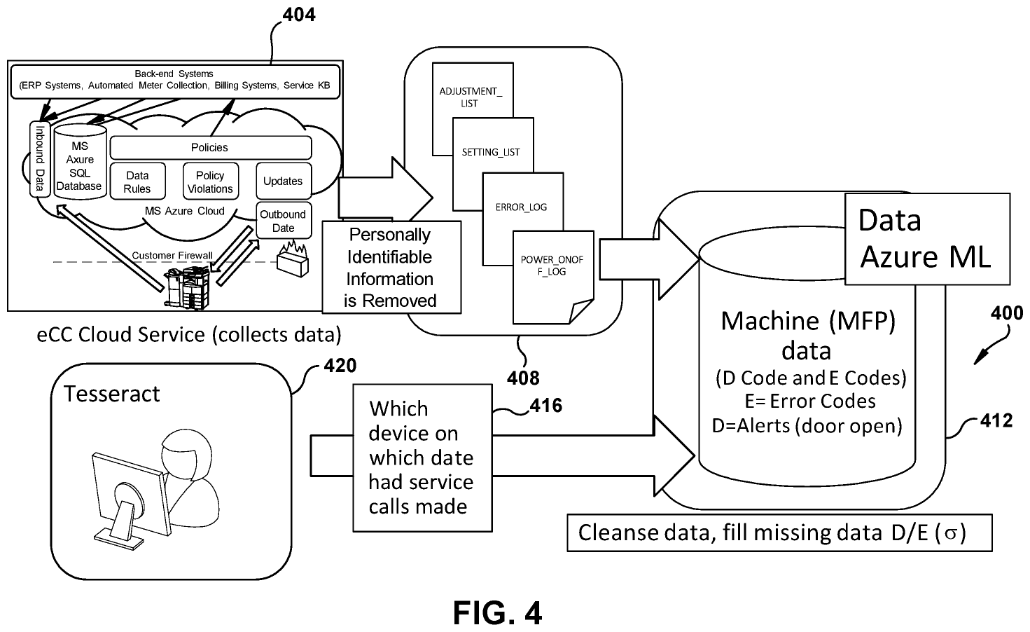

FIG. 4 is a flow diagram of a device error prediction system 400 such as one implemented in conjunction with server 116 of FIG. 1. Device monitoring is suitably accomplished with a device management system 404. By way of particular example, Toshiba TEC MFP devices are configurable and monitored via their e-BRIDGE CloudConnect (eCC web) interface. e-BRIDGE CloudConnect is an integrated system of embedded and cloud-based applications that provide functionality to support remote monitoring and management of Toshiba MFPs. It enables management of configuration settings through automated interaction. e-BRIDGE CloudConnect gathers service information from connected MFPs, including meter data, to speed issue diagnosis and resolution.

Device management system 404 provides device state information 408 for application of machine learning and analysis for predictive device failures by a suitable machine learning platform 412 such as Microsoft Azure. Additional information 416 for such prediction, such as device service log information, is provided by a suitable CMMS (Computerized Maintenance Management System (or Software)) 420, and is sometimes referred to as Enterprise Asset Management (EAM). By way of particular example a CMMS system 420 can be based on CMMS Software, Field Service Software, or Field Force Automation Software provided by Tessaract Corporation.

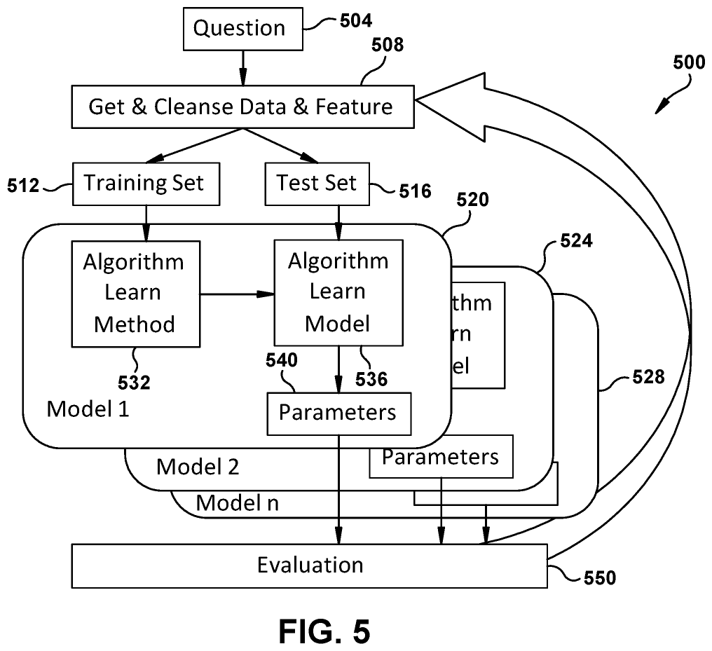

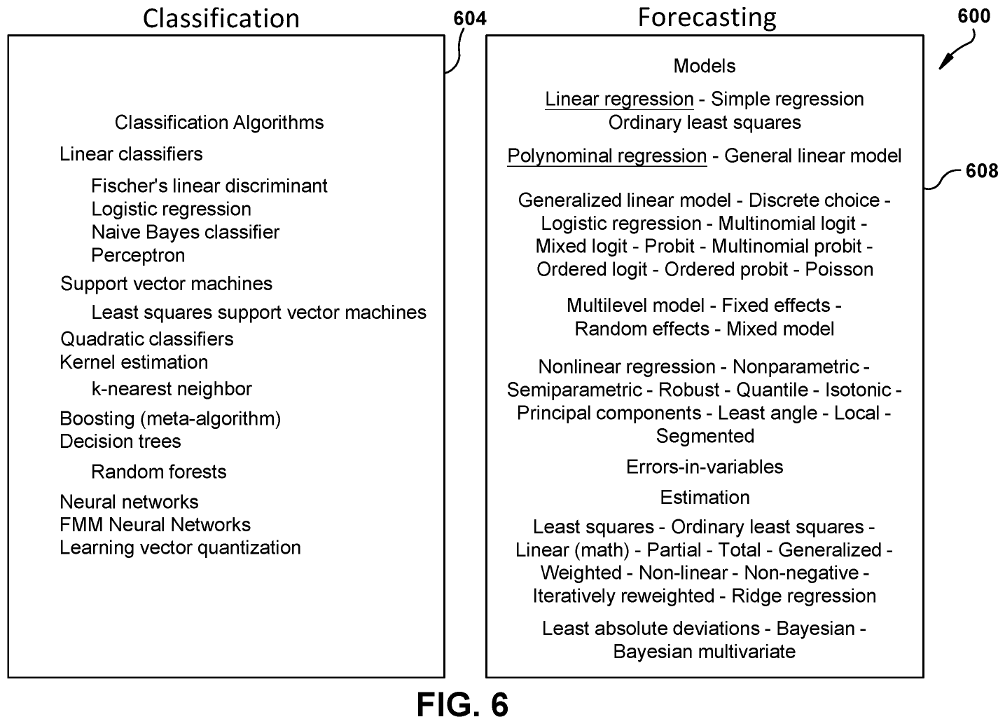

FIG. 5 illustrates a flow diagram 500 of an example embodiment of a machine learning system. In the example system, the process starts with one or more questions 504, such as when will a device likely fail and what aspects or aspects will be associated with such failure. Data is retrieved and cleansed of unneeded or problematic data at data acquisition 508 and this data is provided for both training in a training set 512 and testing in a test set 516. These results are provided to a machine learning system, suitably comprised of one or more learning models such as learning model 1 520, learning model 2 524, and learning model n 528. Each learning model 520, 524, 528 includes one or more algorithm learn methods, such as algorithm learn methods 532 and 536 of learning model 1 520. Parameters, such as parameters 540 of learning model 1 520, are provided for evaluation at 550, and results are fed back to data acquisition at 508 for iterative calculation. FIG. 6 provides example machine learning algorithms 600 including classification algorithms 604 and forecasting algorithms 608.

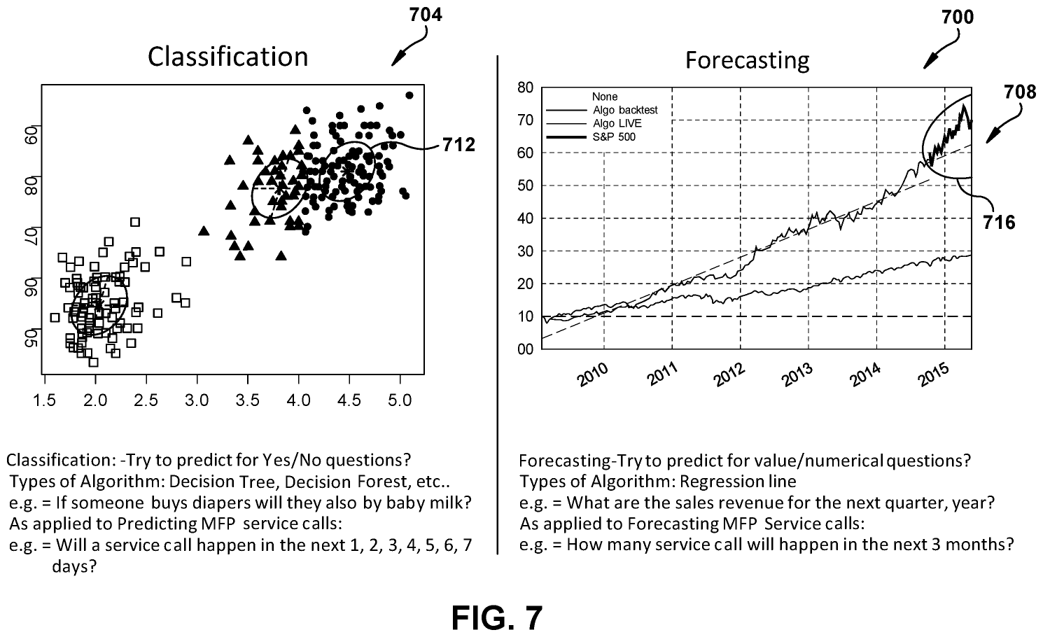

FIG. 7 provides example visual depictions of algorithm results 700, including classification results 704 and forecasting results 708. Device clusters, such as cluster 712, may be indicative of device error conditions with corresponding failure forecasting with results 716. For example, device failure can be forecasted in accordance with an application of a generalized extreme Studentized deviate test as would be understood in the art.

By way of particular example, a determination of the likelihood of a forthcoming service call can be utilized to schedule device maintenance. Such scheduling is suitably integrated with service calls already scheduled or with servicing of two or more geographically proximate devices to minimize travel time needed for technician on-site visits. Suitable machine learning systems are built on available third party platforms such as R-Script, Microsoft Azure, Google Next, Kaggle.com or the like.

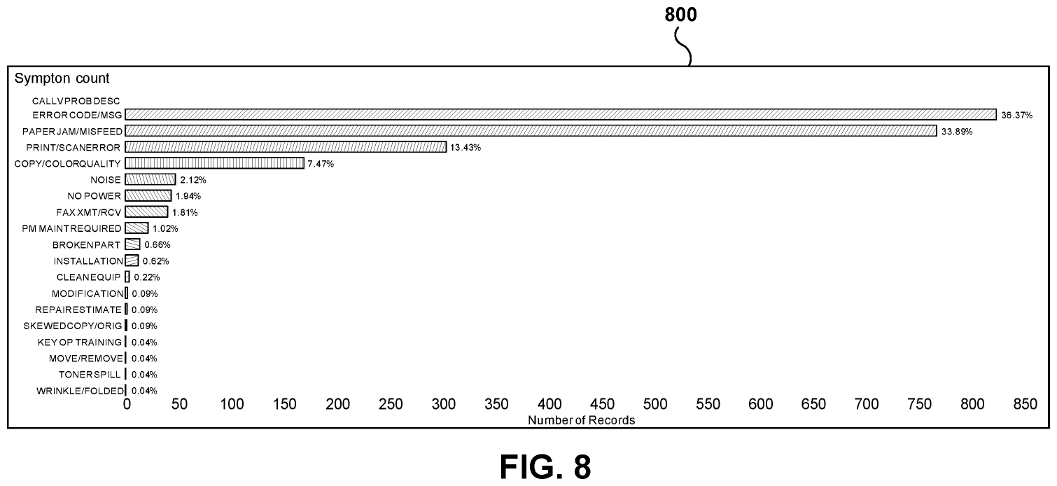

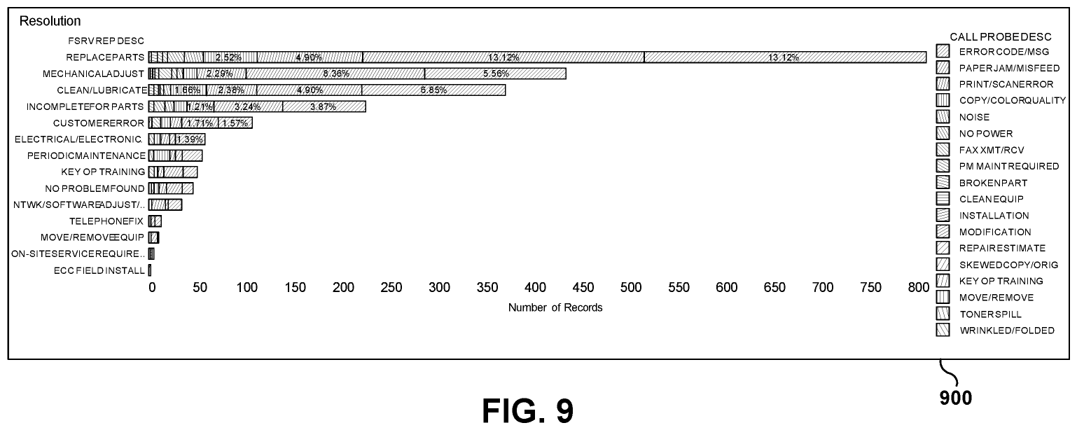

FIG. 8 is an example embodiment of a breakdown of device symptoms 800 for determination of service call likelihood relative to predictive parts needed. FIG. 9 is an example embodiment of resolutions 900 comprising needed replacement parts.

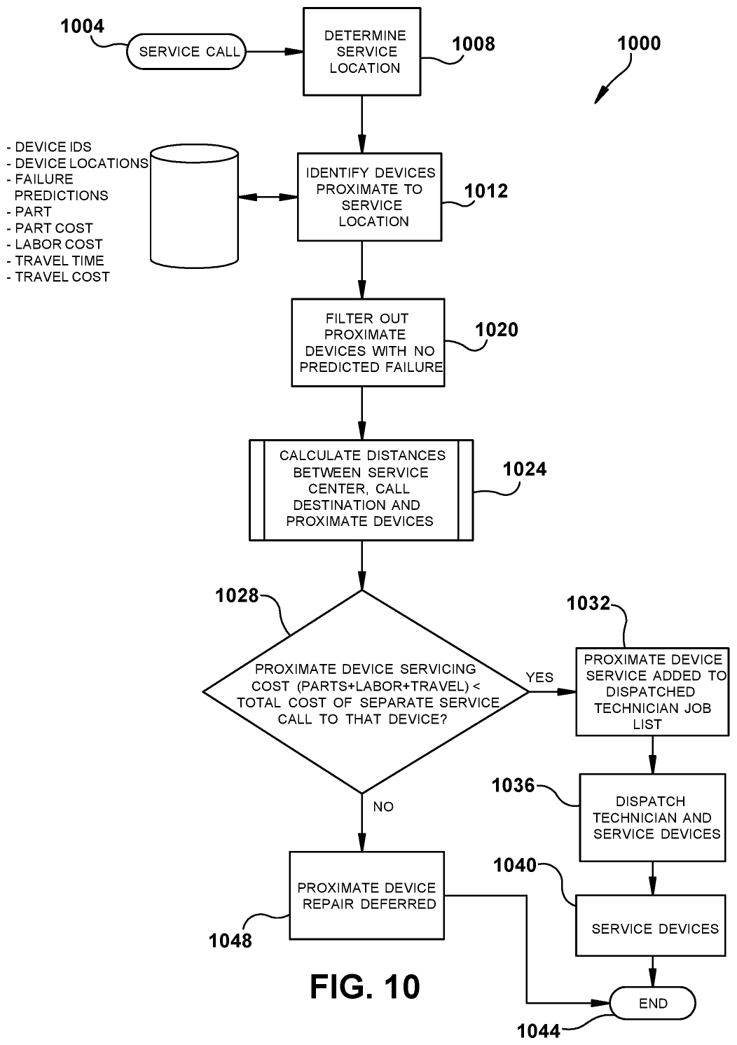

FIG. 10 is a flowchart 1000 of an example embodiment of a system for economically driven predictive device servicing, suitably implemented on server 116 of FIG. 1. The process commences at block 1004 when a device service call is received. Next, a location of a device associated with a received service call is determined at block 1008, and devices within a prescribed distance or boundary are located via query to database 1012. Database 1012 also stores device identifiers, such as serial numbers, device locations, parts or device failure data, part costs labor costs, mileage costs, travel time and the like. Proximate devices with no imminent predictive failure are filtered out at block 1020. Next, distances are calculated between a device location for the service call and proximate devices at block 1024. Next, for each device, at block 1028, a determination is made whether adding a service call for proximate devices is made. Such determination is suitably made as a function of servicing cost, including part cost, labor cost and travel cost. When such cost is less than the cost of a separate service call to that device, it is added to a device service list at block 1032. When the list is complete, a technician is dispatched, along with required parts retrieved from inventory, at block 1036. Devices in the list are serviced at block 1040 and the process ends at block 1044. Any device not meeting the cost criteria of block 1028 is eliminated from the device list at block 1048.

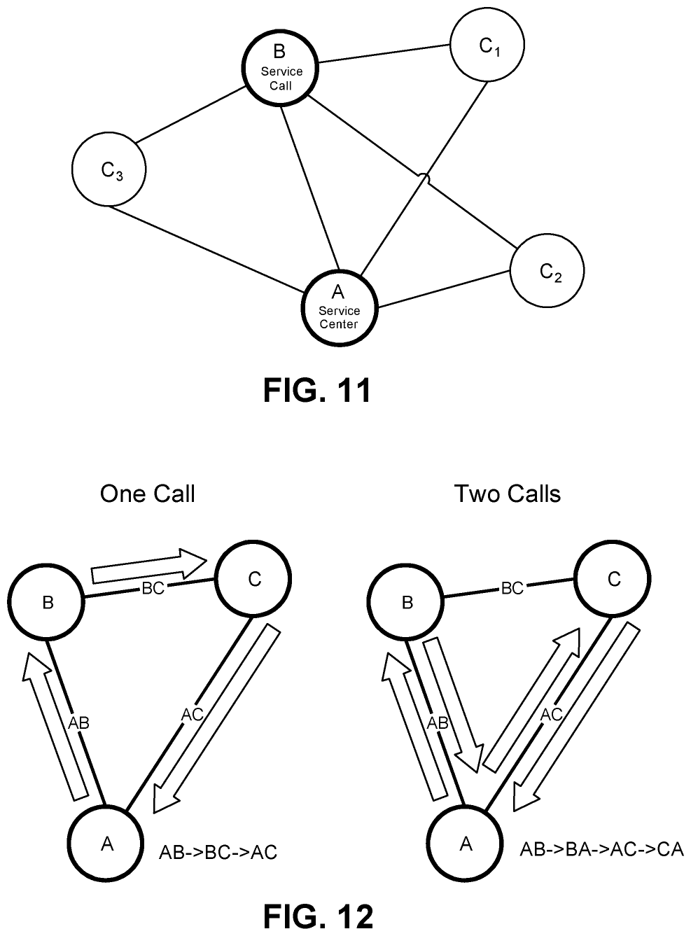

FIG. 11 is an example embodiment of an undirected, weighted graph where a starting node, A, represents the service center from where technicians are dispatched. A second node, B, is a location of the device that will be serviced during the call. All other nodes Cₙ are locations of adjacent devices which have predicted failures. Nodes A and B are connected, and all other nodes are connected to both A and B, their edge weights representing physical distance between the locations of each node.

FIG. 12 illustrates an example embodiment of weighted graphs facilitating determination if servicing the device at C during the same service call at B is cost effective. Units are provided to demonstrate a cost effectiveness calculation.

In the illustrated example:
The physical distances between A, B, C in miles (AB, AC, BC)
An average rate of travel between nodes in miles per hour (m)
Transportation cost (e.g. fuel, vehicle depreciation) in dollars per mile (t)
Service technician cost in dollars per hour (w)
A cost of the a predicted to fail at C in dollars (f)
A precision of the predictive maintenance model (p)
A determination is made that it is cost effective for a technician to replace predicted failing part at C while on a call to B if the expected cost of replacing the part at C in the same trip is less than replacing it in a separate trip:

$$w \frac{B C}{m} + \frac{f}{p} < \frac{w ( A B + A C )}{m} + f$$

Note that the cost of the part is weighted inversely by the precision of the predictive model in the scenario where the part at C is replaced in the same trip. This facilities accounting for potential lost value (higher cost of the part) if the prediction is incorrect and the part at C is replaced before its effective life is up.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor;
a memory storing predictive parts failure data for each of a plurality of identified multifunction peripherals at an identified location;
the memory further storing cost data corresponding to a replacement cost associated with each of a plurality of replacement parts;
an input configured to receive service call data associated with a service call at a specified location;
the processor configured to identify a subset of the plurality of multifunction peripherals within a specified distance boundary relative to the specified location;
the processor further configured to identify serviceable devices from the subset, which serviceable devices have a predicted failure;
the processor further configured to determine which of the serviceable devices are cost effectively serviced contemporaneously with a device service associated with the service call;
the processor further configured to generate a device service list for cost effectively serviceable devices; and
the processor further configured to dispatch a technician to service devices in the device service list.

2. The system of claim 1 wherein the processor is further configured to determine which devices are cost effectively serviced in accordance with an identified repair part cost.

3. The system of claim 2 wherein the processor is further configured to determine which devices are cost effectively serviced in accordance with a labor cost for installation of the identified repair part.

4. The system of claim 3 wherein the processor is further configured to determine which devices are cost effectively serviced in accordance with service technician travel distance.

5. The system of claim 4 wherein the processor is further configured to determine which devices are cost effectively serviced in accordance with a precision of predicted part failures.

6. The system of claim 3 wherein the processor is further configured to determine which devices are cost effectively serviced in accordance with technician travel time and transportation cost.

7. The system of claim 6 wherein the transportation cost comprises vehicle cost and fuel cost.

8. The system of claim 1 wherein the processor is further configured to determine which devices are cost effectively serviced in accordance with serviceable devices at three locations comprising nodes A, B and C in accordance with the equation:
$$w \frac{B C}{m} + \frac{f}{p} < \frac{w ( A B + A C )}{m} + f$$
wherein,
w represents a technician cost,
AB represents a distance between node A and node B,
BC represents a distance between node B and node A,
AC represents a distance between location A and location C,
m represents an average rate of travel between nodes,
f represents a cost of a part predicted to fail, and
p represents predictive maintenance model precision.

9. A method comprising:
storing, in a memory, predictive parts failure data for each of a plurality of identified multifunction peripherals at an identified location;
storing, in the memory, cost data corresponding to a replacement cost associated with each of a plurality of replacement parts;
receiving service call data associated with a service call at a specified location;
identifying serviceable devices from the subset, which serviceable devices have a predicted failure;
determining which of the serviceable devices are cost effectively serviced contemporaneously with a device service associated with the service call;
generating a device service list for cost effectively serviceable devices;
dispatching a technician to service the cost effectively serviceable devices; and
replacing parts predicted to fail in devices in the device service list.

10. The method of claim 9 further comprising determining which devices are cost effectively serviced in accordance with an identified repair part cost.

11. The method of claim 10 further comprising determining which devices are cost effectively serviced in accordance with a labor cost for installation of the identified repair part.

12. The method of claim 11 further comprising determining which devices are cost effectively serviced in accordance with service technician travel distance.

13. The method of claim 12 further comprising determining which devices are cost effectively serviced in accordance with a precision of predicted part failures.

14. The method of claim 11 further comprising determining which devices are cost effectively serviced in accordance with technician travel time and transportation cost.

15. The method of claim 14 wherein the transportation cost comprises vehicle cost and fuel cost.

16. The method of claim 9 wherein further comprising determining which devices are cost effectively serviced in accordance with serviceable devices at three locations comprising nodes A, B and C in accordance with the equation:
$$w \frac{B C}{m} + \frac{f}{p} < \frac{w ( A B + A C )}{m} + f$$
wherein,
w represents a technician cost,
AB represents a distance between node A and node B,
BC represents a distance between node B and node A,
AC represents a distance between location A and location C,
m represents an average rate of travel between nodes,
f represents a cost of a part predicted to fail, and
p represents predictive maintenance model precision.

17. A method comprising:
storing, in a memory, predictive parts failure data for each of a plurality of identified multifunction peripherals at an identified location;
storing, in the memory, cost data corresponding to a replacement cost associated with each of a plurality of replacement parts;
receiving service call data associated with a service call at a specified location;
identifying serviceable devices from the subset, which serviceable devices have a predicted parts failure;
determining which of the serviceable devices are cost effectively serviced contemporaneously with a device service associated with the service call in accordance with an associated, predicted time to a part failure relative to part cost;
generating a device service list for cost effectively serviceable devices;
retrieving parts from inventory for servicing of devices in the device service list;
dispatching a technician to service devices in the device service last; and
replacing parts in the devices in the device service list with parts retrieved from inventory.

18. The method of claim 17 further comprising determining which of the serviceable devices are cost effectively serviced contemporaneously with an associated service cost for devices in the device list.

19. The method of claim 18 wherein service cost includes technician time cost and transportation cost.

20. The method of 17 further comprising determining which of the serviceable devices are cost effectively serviced contemporaneously in accordance with predictive parts failure accuracy.
